(19) United States
(12) Patent Application Publication
(10) Pub. No.: US 2021/0059446 A1
(43) Pub. Date: Mar. 4, 2021

(54) EDIBLE DRINKING STRAW

(71) Applicant: STEVE GILL, Seaside, CA (US)

(72) Inventor: STEVE GILL, Seaside, CA (US)

(21) Appl. No.: 16/551,875

(22) Filed: Aug. 27, 2019

(51) Int. Cl. A47G 21/18; A23G 3/54

(52) U.S. Cl. CPC A47G 21/18; A23V 2002/00; A47G 2400/105; A23G 3/545

(57) ABSTRACT

The edible drinking straw is a foodstuff. The edible drinking straw is configured for use with a liquid foodstuff. The edible drinking straw is a straw that draws the liquid foodstuff from a container. The edible drinking straw is consumed after the liquid foodstuff has been consumed from the container. The edible drinking straw comprises a shell and a rouleau. The rouleau is formed through the shell. The shell is formed from a fluid impermeable material. The liquid foodstuff is drawn from the container through the rouleau.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of domestic articles including tableware, more specifically, an extruded drinking straw. (A47G21/18)

### SUMMARY OF INVENTION

The edible drinking straw is a foodstuff. The edible drinking straw is configured for use with a liquid foodstuff. The edible drinking straw is a straw that draws the liquid foodstuff from a container. The edible drinking straw is consumed after the liquid foodstuff has been consumed from the container. The edible drinking straw comprises a shell and a rouleau. The rouleau is formed through the shell. The shell is formed from a fluid impermeable material. The liquid foodstuff is drawn from the container through the rouleau.

These together with additional objects, features and advantages of the edible drinking straw will be readily apparent to those of ordinary skill in the art upon reading the following detailed description of the presently preferred, but nonetheless illustrative, embodiments when taken in conjunction with the accompanying drawings.

In this respect, before explaining the current embodiments of the edible drinking straw in detail, it is to be understood that the edible drinking straw is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the edible drinking straw.

It is therefore important that the claims be regarded as including such equivalent construction insofar as they do not depart from the spirit and scope of the edible drinking straw. It is also to be understood that the phraseology and terminology employed herein are for purposes of description and should not be regarded as limiting.

### BRIEF DESCRIPTION OF DRAWINGS

The accompanying drawings, which are included to provide a constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a cross-sectional view of an embodiment of the disclosure across 3-3 as shown in FIG. 2.

FIG. 4 is an in-use view of an embodiment of the disclosure.

FIG. 5 is a detail view of an embodiment of the disclosure.

FIG. 6 is a detail view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

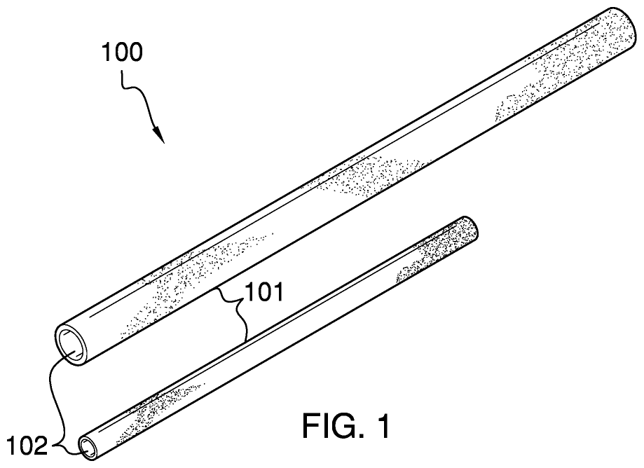

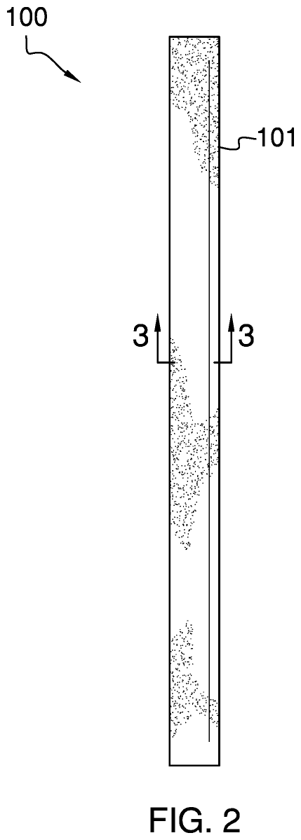

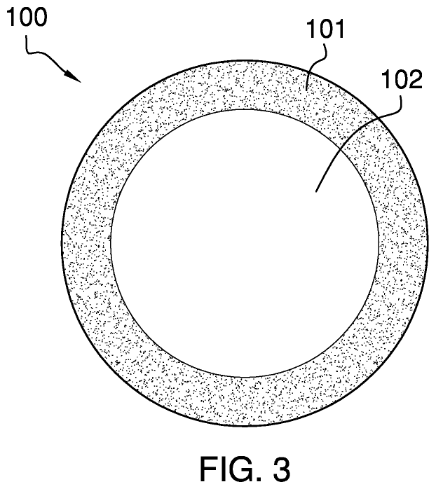

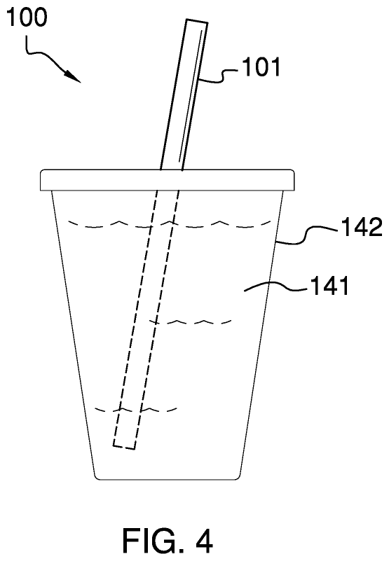

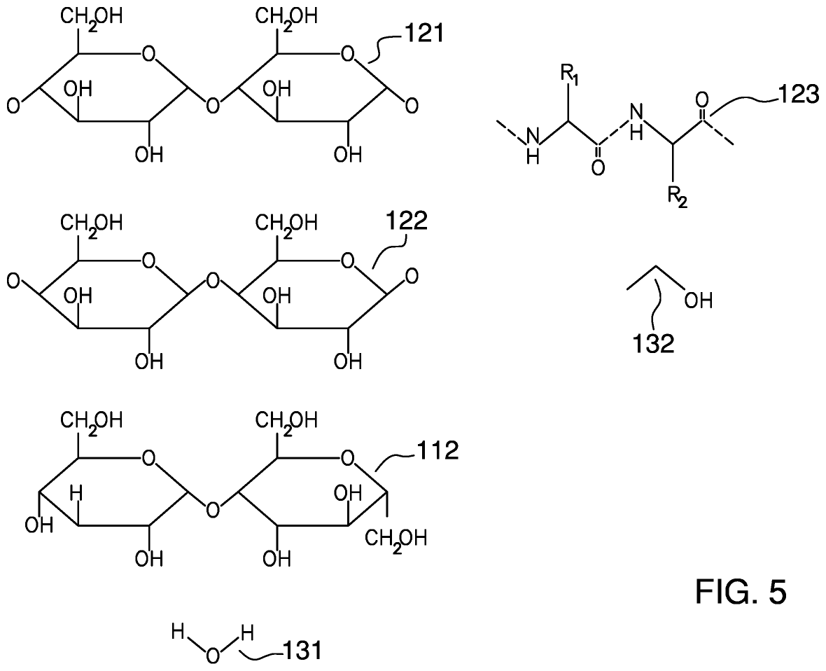

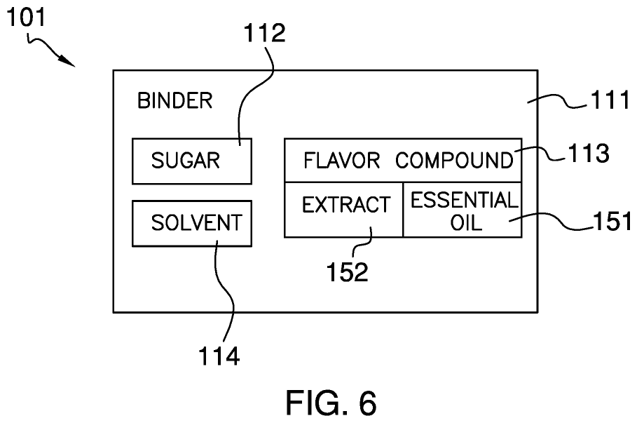

Detailed reference will now be made to one or more potential embodiments of the disclosure, which are illustrated in FIGS. 1 through 6.

The edible drinking straw 100 (hereinafter invention) is a foodstuff. The invention 100 is configured for use with a liquid foodstuff 141. The invention 100 is a straw that draws the liquid foodstuff 141 from a container 142. The invention 100 is consumed after the liquid foodstuff 141 has been consumed from the container 142. The invention 100 comprises a shell 101 and a rouleau 102. The rouleau 102 is formed through the shell 101. The shell 101 is formed from a fluid impermeable material. The liquid foodstuff 141 is drawn from the container 142 through the rouleau 102.

The liquid foodstuff 141 is a liquid phase beverage hollow structure used to store the liquid foodstuff 141 before consumption.

The shell 101 forms the exterior surface of the invention 100. The shell 101 is a hollow prism-shaped structure. The shell 101 forms a fluid impermeable structure. The shell 101 has a gel structure. The shell 101 transports the liquid foodstuff 141 from the container 142 when suction is applied to the shell 101. The shell 101 contains the liquid foodstuff 141 as the liquid foodstuff 141 passes through the invention 100. The shell 101 is formed as a foodstuff such that the shell 101 can be consumed after transporting the liquid foodstuff 141 from the container 142. The shell 101 comprises a binder 111, a sugar 112, a flavor compound 113, and a solvent 114.

The binder 111 forms a cross-linked network structure that captures the solvent 114, the sugar 112, and the flavor compound 113 to form the gel structure of the binder 111. The binder 111 is a material that is safe for consumption by humans. The binder 111 combines with the solvent 114 to form a paste structure that allows the shell 101 to be formed using an extrusion process. The solvent 114 brings into the cross-linked structure of the binder 111 both the sugar 112 and the flavor compound 113 such that the sugar 112 and the flavor compound 113 are also captured in the cross-linked structure of the binder structure that is sweetened by the flavor compound 113 and flavored by the solvent 114.

The binder 111 is selected from the group consisting of a starch 121, a cellulose 122, and a protein 123.

The starch 121 is a polymer structure formed from a chain of alpha-D-glucose (CAS 492-62-6) molecules. The starch 121 mixes with the solvent 114 to form the cross-linked network structure that captures the sugar 112 and the flavor compound 113 within the cross-linked network structure formed by the starch 121. The starch 121 is defined elsewhere in this disclosure.

The cellulose 122 is a polymer structure formed from a chain of beta-D-glucose (CAS 492-61-5) molecules. The cellulose 122 mixes with the solvent 114 to form the cross-linked network structure that captures the sugar 112 and the flavor compound 113 within the cross-linked network structure formed by the cellulose 122. The cellulose 122 is defined elsewhere in this disclosure.

The protein 123 is a polymer structure formed from a chain of amino acid molecules. The protein 123 mixes with the solvent 114 to form the cross-linked network structure that captures the sugar 112 and the flavor compound 113 within the cross-linked network structure formed by the protein 123. The protein 123 is The sugar 112 is a carbohydrate with a relatively low molecular weight. By relatively low molecular weight is meant a molecular weight of less than 350 Daltons. The sugar 112 is soluble in a polar solvent such as water 131. The sugar 112 provides the foodstuff formed by the shell 101 with a sweet taste that is consistent with the taste of candy. The sugar 112 is dissolved in the solvent 114 during the production process such that the crosslinked structure formed by the binder 111 will capture the sugar 112 when the binder 111 is mixed with the solvent 114.

The flavor compound 113 is a chemical compound. The flavor compound 113 is safe for consumption by a human. The flavor compound 113 exists in a format selected from the group consisting of: a) a solution wherein the flavor compound 113 is a solute dissolved in the solvent 114; and, b) an emulsion formed between the flavor compound 113 and the solvent 114. The flavor compound 113 provides the foodstuff formed by the shell 101 with a taste characteristic to the selected flavor compound 113. The flavor compound 113 is selected from the group consisting of an essential oil 151 and an extract 152.

The essential oil 151 is a phytochemical derived from a plant that is dissolved in a liquid phase lipid. The essential oil 151 is defined elsewhere in this disclosure. The extract a liquid phase polar solvent. The extract 152 is defined elsewhere in this disclosure.

The solvent 114 is a liquid phase chemical compound. The solvent 114 forms a polar solvent. The solvent 114 forms a solution with the sugar 112. The solvent 114 mixes with the flavor compound 113 as a structure selected from the group consisting of a solution and an emulsion. The chemical compound formed from the mixture of the sugar 112 and the flavor compound 113 in the solvent 114 is then mixed with the binder 111 to form a paste used to create the gel structure of the shell 101. The paste formed by the mixture of the binder 111, the sugar 112, the flavor compound 113, and the solvent 114 is extruded through a die to form the tubular structure of the shell 101. The solvent 114 is selected from the group consisting of: a) water 131; and, b) a solution formed from water 131 and ethanol 132.

The water 131 is a polar molecule. The water 131 has a liquid phase at normal temperature and pressure. The water 131 forms a portion, or all, of the solvent 114 used to form the physical structure of the shell 101. The ethanol 132 is a polar molecule. The ethanol 132 has a liquid phase at normal temperature and pressure. The ethanol 132 forms a portion of the solvent 114 used to form the physical structure of the shell 101.

The rouleau 102 is a negative space that is formed through the shell 101. The rouleau 102 forms the fluid transport path for the liquid foodstuff 141. The rouleau 102 is a prism-shaped structure that is geometrically similar to the prism structure of the shell 101. The center axis of the prism structure of the rouleau 102 aligns with the center axis of the prism structure of the shell 101.

The following definitions were used in this disclosure:

Alcohol: As used in this disclosure, an alcohol refers to an organic chemical structure that comprises a hydroxyl functional group.

Amide: As used in this disclosure, an amide is a functional group with a structure selected from the group consisting of: R1-(C═O)—(NH2), R1-(C═O)—(NH—R2), and R1-(C═O)—(NR2-R3). In this configuration, R1, R2, and R3 are organic molecules and R2 and R3 bond directly to the nitrogen (N). A polyamide refers to a polymer chain where the monomers are joined using an amide bond.

Amine Functional Group: As used in this disclosure, the amine functional group is a functional group with the chemical formula —NH2.

Amino Acid: As used in this disclosure, an amino acid refers to a carbon atom that has a carboxyl functional group and the twenty to twenty two-amino acids commonly used for biological functions. The range of twenty to twenty-two depends on the specific context: the first twenty amino acids refer to the amino acids that are incorporated into proteins using the normal biosynthetic process while two additional amino acids can be incorporated into proteins using alternate biological mechanisms.

Carboxylic Acid: As used in this disclosure, a carboxylic acid is an organic molecule that further comprises the carboxyl functional group.

Carboxyl Functional Group: As used in this disclosure, the carboxyl functional group is a functional group with the chemical formula —COOH.

Carbohydrate: As used in this disclosure, a carbohydrate refers to a polymer chain formed from sugar molecules. The chemical formula of carbohydrates takes the general form of Cx(H2O)x where x is a positive integer. Carbohydrates are often referred to as a starch.

Cellulose: As used in this disclosure, a starch is a polymer formed from monomers of beta-D-glucose (CAS 492-61-5) molecules. Cellulose is an insoluble substance that is the main constituent of plant cell walls and vegetable fibers such as cotton.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Channel: As used in this disclosure, a channel is a tubular passage through which an object or fluid is passed through.

Colloidal Suspension: As used in this disclosure, a colloidal suspension, or colloid for short, is a heterogeneous mixture of solute particles dissolved in a solvent. The colloidal suspension is referred to as heterogeneous because the distribution of the solute particles is not uniform through the solvent, usually because of the relatively large size of the particles. When the solvent is a gas, a colloidal suspension is often referred to as an aerosol.

Color: As used in this disclosure, a color refers to the visible portion of the spectrum that is reflected off of an object that is exposed to an external source of electromagnetic radiation. A color is often referred to as a shade.

Color Spectrum: As used in this disclosure, a color spectrum refers to an organization of ranges visible electromagnetic radiation into specific colors. Within this disclosure: a) electromagnetic radiation with wavelengths of 380 nm to 450 nm are called violet; b) electromagnetic radiation with wavelengths of 450 nm to 485 nm are called blue; c) electromagnetic radiation with wavelengths of 485 nm to 500 nm are called cyan; d) electromagnetic radiation with wavelengths of 500 nm to 565 nm are called green; e) electromagnetic radiation with wavelengths of 565 nm to 590 nm are called yellow; f) electromagnetic radiation with wavelengths of 590 nm to 625 nm are called orange; and, g) electromagnetic radiation with wavelengths of 625 nm to 740 nm are called red.

Die: As used in this disclosure, a die is a device used for mechanically cutting or molding a material.

Dissolve: As used in this disclosure, to dissolve refers to the incorporation of a solute into a solvent to form a solution.

Dye: As used in this disclosure, a dye is a chemical composition used to change the color of an object. The verb to dye refers to the use of one or more dyes to create a hue on an object.

Emulsion: As used in this disclosure, an emulsion is a dispersion of droplets or miscelles of a first liquid in a second liquid in which the first liquid and second liquid are not soluble or miscible.

Essential Oil: As used in this disclosure, an essential oil is a lipid-based solution that contains one or more volatile aroma compounds. Examples of essential oils include, but are not limited to, basil oil, black pepper oil, caraway oil, cannabis flower oil, cedar wood oil, cinnamon oil, citronella oil, chamomile oil, clove oil, davana oil, eucalyptus oil, frankincense oil, horseradish oil, jasmine oil, lavender oil, lemon oil, lemongrass oil, mandarin oil, nutmeg oil, orange oil, oregano oil, peppermint oil, pine oil, sage oil, sandalwood oil, star anise oil, and thyme oil. Basil oil, cedar wood oil, citronella oil, chamomile oil, clove oil, lavender oil, lemongrass oil, and peppermint oil are traditionally considered to have insect repellent properties.

Ethanol: As used in this disclosure, ethanol (CAS 64-17-5) is a chemical substance with the chemical formula C2H5OH.

Extract: As used in this disclosure, an extract is a solution that contains one or more phytochemicals dissolved in a polar solvent such as a mixture of ethanol and water.

Extrusion: As used in this disclosure, extrusion refers to a method of shaping a viscous material, such as a viscous colloid or a viscous emulsion, through an aperture formed in a die.

Flow: As used in this disclosure, a flow refers to the passage of a fluid past a fixed point. This definition considers bulk solid materials as capable of flow.

Fluid: As used in this disclosure, a fluid refers to a state of matter wherein the matter is capable of flow and takes the shape of a container it is placed within. The term fluid commonly refers to a liquid or a gas.

Foodstuff: As used in this disclosure, a foodstuff refers to an edible material that is used as food or a beverage.

Functional Group: As used in this disclosure, a functional group is a specific chemical structure that 1) defines the structure of a chemical family; and, 2) determines the properties of the chemical family. Common functional groups include, but are not limited to, aldehydes, alkanes, alkenes, alkynes, alcohols, amides, amines, carboxylic acids, esters, ethers, haloalkanes, haloalkenes, haloalkynes, and ketones. As a practical matter, the intention of this definition is to use the term functional group in the same manner as the term is commonly used in organic chemistry.

Gas: As used in this disclosure, a gas refers to a state (phase) of matter that is fluid and that fills the volume of the structure that contains it. Stated differently, the volume of a gas always equals the volume of its container.

Gel: As used in this disclosure, a gel is a substance comprising a liquid that is trapped in a cross-linked network structure that exhibits the properties of a solid.

Glycerol: As used in this disclosure, glycerol (CAS 56-81-5) is a name for 1, 2, 3 propanetriol which has the chemical formula CH₂OHCHOHCH₂OH. Glycerol is also called glycerin.

Glyceride: As used in this disclosure, the term glyceride refers to a compound that contains glycerol.

Hue: As used in this disclosure, a hue refers to a specific color.

Lipid: As used in this disclosure, a lipid is an organic molecule that is soluble in nonpolar solvents.

Liquid: As used in this disclosure, a liquid refers to a state (phase) of matter that is fluid and that maintains, for a given pressure, a fixed volume that is independent of the volume of the container.

Negative Space: As used in this disclosure, negative space is a method of defining an object through the use of open or empty space as the definition of the object itself, or, through the use of open or empty space to describe the boundaries of an object.

Normal Temperature and Pressure: As used in this disclosure, normal temperature and pressure refers to gas storage conditions corresponding to 20 degrees C. at 100 kPa (approx. 1 atmosphere). Normal temperature and pressure is often abbreviated as NTP.

Paste: As used in this disclosure, a paste is a viscous colloidal material with a viscosity that allows the paste to be treated as a malleable solid.

Peptide: As used in this disclosure, a peptide refers to a molecular sequence formed with one or more bonds between two or more amino acids. Unless otherwise stated in this disclosure, the amino acids are not limited to the standard amino acids.

Pharmacologically Active Media: As used in this disclosure, a pharmacologically active media refers to a chemical substance that has a biochemical or physiological effect on a biological organism.

Phase: As used in this disclosure, phase refers to the state of the form of matter. The common states of matter are solid, liquid, gas, and plasma.

Phytochemical: As used in this disclosure, a phytochemical is a pharmacologically active media that is produced in and harvested from a plant.

Plant: As used in this disclosure, a plant is a biological organism: 1) that is not capable of movement over significant distances; and 2) that uses photosynthesis to create nutrients. A stationary biological organism that is not capable of movement over significant distances but does not use photosynthesis is referred to as a parasitic plant. In the vernacular, the term plant will often include parasitic plants. The intention of this disclosure is to include parasitic plants in the definition of plant.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Protein: As used in this disclosure, a protein refers to a linear molecular sequence of amino acids. Unless otherwise stated in this disclosure, a protein is exclusively formed from the standard amino acids.

Rouleau: As used in this disclosure, a rouleau is a negative space that is formed through a structure.

Solid: As used in this disclosure, a solid refers to a state (phase) of matter that: 1) has a fixed volume; and, 2) does not flow.

Solution: As used in this disclosure, a solution is a uniform mixture of two or more compounds in a liquid phase. The major component selected of the solution selected from the two or more compounds is called the solvent. The components remaining in the two or more compounds are called the solute.

Spectrum: As used in this disclosure, a spectrum refers to the distribution and amplitude of the component frequencies of a source of electromagnetic radiation. Spectrums are typically organized and displayed by frequency or frequency range.

Starch: As used in this disclosure, a starch is a polymer formed from monomers of alpha-D-glucose (CAS 492-62-6) molecules.

Straw: As used in this disclosure, a straw refers to a tubular structure used to transport a liquid foodstuff from a container.

Suction: As used in this disclosure, suction refers to the generation of a vacuum that is used to transport a fluid.

Sugar: As used in this disclosure, a sugar refers to a carbohydrate that readily dissolves in water. This disclosure assumes that the carbohydrate that forms the sugar contains 12 or fewer carbon atoms.

Tube: As used in this disclosure, a tube is a hollow prism-shaped device formed with two open ends. The tube is used for transporting liquids and gases. The line that connects the center of the first congruent face of the prism to the center of the second congruent face of the prism is referred to as the center axis of the tube or the centerline of the tube. When two tubes share the same centerline they are said to be aligned. When the centerlines of two tubes are perpendicular to each other, the tubes are said to be perpendicular to each other. In this disclosure, the terms inner dimensions of a tube and outer dimensions of a tube are used as they would be used by those skilled in the plumbing arts.

Vacuum: As used in this disclosure, vacuum is used to describe a first space that contains gas at a reduced gas pressure relative to the gas pressure of a second space. If the first space and the second space are connected together, this pressure differential will cause gas from the second space to move towards the first space until the pressure differential is eliminated.

Viscous Colloid: As used in this disclosure, a viscous colloid is a colloidal suspension where the viscosity or flow rate of the colloid is such that the colloid will flow but can for all practical purposes be treated and contained as if it were a solid. In common usages, a viscous colloid is often referred to as a cream.

Viscosity: As used in this disclosure, viscosity refers to the resistance of a liquid or an elastic material to deformation. Higher viscosity would refer to a greater resistance to flow or to deformation.

Water: As used in this disclosure, water (CAS 7732-18-5) is a molecule comprising two hydrogen atoms and one oxygen molecule. The phase of water at normal temperature and pressure is liquid. As used in this disclosure, the definition of water is expanded to include dilute water-based solutions of salts and ionic structures using water as the solvent.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

1. An edible drinking straw comprising
a shell and a rouleau;
wherein the rouleau is formed through the shell;
wherein the edible drinking straw is a foodstuff;
wherein the edible drinking straw is configured for use with a liquid foodstuff;
wherein the edible drinking straw is a straw that draws the liquid foodstuff from a container;
wherein the edible drinking straw is consumed after the liquid foodstuff has been consumed from the container;
wherein the shell forms a fluid impermeable structure;
wherein the liquid foodstuff is drawn from the container through the Rouleau;
wherein the shell forms the exterior surface of the edible drinking straw;
wherein the shell is a hollow prism-shaped structure;
wherein the shell is formed from a fluid impermeable material;
wherein the shell has a gel structure;
wherein the shell contains the liquid foodstuff as the liquid foodstuff passes through the edible drinking straw;
wherein the shell comprises a binder, a sugar, a flavor compound, and a solvent;
wherein the binder forms a cross-linked network structure that captures the solvent, the sugar, and the flavor compound to form the gel structure of the binder;
wherein the binder is selected from the group consisting of a starch, a cellulose, and a protein;
wherein the starch is a polymer structure formed from a chain of alpha-D-glucose (CAS 492-62-6) molecules.

2. (canceled)

3. (canceled)

4. (canceled)

5. The edible drinking straw according to claim 1
wherein the rouleau is a negative space that is formed through the shell;
wherein the rouleau forms the fluid transport path for the liquid foodstuff;
wherein the rouleau is a prism-shaped structure that is geometrically similar to the prism structure of the shell;
wherein the center axis of the prism structure of the rouleau aligns with the center axis of the prism structure of the shell.

6. (canceled)

7. The edible drinking straw according to claim 5
wherein the binder is a material that is safe for consumption by humans;
wherein the binder combines with the solvent to form a paste structure that allows the shell to be formed using an extrusion process;
wherein the solvent brings into the cross-linked structure of the binder both the sugar and the flavor compound such that the sugar and the flavor compound are also captured in the cross-linked structure of the binder.

8. The edible drinking straw according to claim 7 wherein the binder is dried after extrusion to form a solid structure that is sweetened by the flavor compound and flavored by the solvent.

9. (canceled)

10. (canceled)

11. The edible drinking straw according to claim 8 wherein the cellulose is a polymer structure formed from a chain of beta-D-glucose (CAS 492-61-5) molecules.

12. The edible drinking straw according to claim 11 wherein the protein is a polymer structure formed from a chain of amino acid molecules.

13. The edible drinking straw according to claim 12 wherein the starch mixes with the solvent to form the cross-linked network structure that captures the sugar and the flavor compound within the cross-linked network structure formed by the starch.

14. The edible drinking straw according to claim 13 wherein the cellulose mixes with the solvent to form the cross-linked network structure that captures the sugar and the flavor compound within the cross-linked network structure formed by the cellulose.

15. The edible drinking straw according to claim 14 wherein the protein mixes with the solvent to form the cross-linked network structure that captures the sugar and the flavor compound within the cross-linked network structure formed by the protein.

16. The edible drinking straw according to claim 15
wherein the sugar is a carbohydrate with a relatively low molecular weight;
wherein by relatively low molecular weight is meant a molecular weight of less than 350 Daltons;
wherein the sugar is soluble in a polar solvent;
wherein the sugar is dissolved in the solvent during the production process such that the crosslinked structure formed by the binder will capture the sugar when the binder is mixed with the solvent.

17. The edible drinking straw according to claim 16
wherein the flavor compound is a chemical compound;
wherein the flavor compound exists in a format selected from the group consisting of: a) a solution wherein the flavor compound is a solute dissolved in the solvent; and, b) an emulsion formed between the flavor compound and the solvent.

18. The edible drinking straw according to claim 17 wherein the flavor compound is selected from the group consisting of an essential oil and an extract.

19. The edible drinking straw according to claim 18
wherein the essential oil is a phytochemical derived from a plant that is dissolved in a liquid phase lipid;
wherein the extract is a phytochemical derived from a plant that is dissolved in a liquid phase polar solvent.

20. The edible drinking straw according to claim 19
wherein the solvent is a liquid phase chemical compound;
wherein the solvent forms a polar solvent;
wherein the solvent forms a solution with the sugar;
wherein the solvent mixes with the flavor compound as a structure selected from the group consisting of a solution and an emulsion;
wherein the chemical compound formed from the mixture of the sugar and the flavor compound in the solvent is then mixed with the binder to form a paste used to create the gel structure of the shell;
wherein the paste formed by the mixture of the binder, the sugar, the flavor compound, and the solvent is extruded through a die to form the tubular structure of the shell;
wherein the solvent is selected from the group consisting of: a) water; and, b) a solution formed from water and ethanol.
